(19) United States
(12) Patent Application Publication
(10) Pub. No.: US 2006/0055308 A1
(43) Pub. Date: Mar. 16, 2006

(54) Plasma display filter with a dielectric/metallic layer stack of at least eleven layers

(76) Inventors: Bruce M. Lairson, Menlo Park, CA (US); Stanley Louie, Oakland, CA (US); Chris R. Schmidt, Palo Alto, CA (US); Erik Gaderlund, Los Altos, CA (US)

Correspondence Address: Terry McHugh;Law Offices of Terry McHugh, PMB 560, 101 First Street, Los Altos, CA, 94022, US

(21) Appl. No.: 10/943,509

(22) Filed: Sep. 16, 2004

(51) Int. Cl. H01J 1/62; H01J 63/04; H01J 17/49

(52) U.S. Cl. 313/489; 313/582; 313/587

(57) ABSTRACT

A plasma display filter includes five metallic layers, such as silver alloy layers, having a combined thickness that exceeds 50 nm. The metallic layers form an alternating pattern with dielectric layers, where the layer in the pattern closest to a supporting substrate is the first of the dielectric layers. Layer thicknesses are selected to achieve a low reflected color shift with changes in the viewing angle, relatively neutral transmitted color properties, and desirable shielding characteristics with respect to infrared and electromagnetic radiation.

### TECHNICAL FIELD

The invention relates generally to optical filters and more particularly to filters for plasma display panels.

### BACKGROUND ART

A number of different factors are considered in the design of an optical filter for a plasma display panel (PDP). The factors include the degree of neutrality of transmitted color, the level of reflected light and the color shift with changes in the incidence angle of a viewer, and the transmission levels of infrared and electromagnetic radiation. Unfortunately, modifying a filter to increase conditions with respect to one factor sometimes conflicts with maintaining a target level for another factor.

FIG. 1 is one possible arrangement of layers to provide a filter for a plasma display panel, which includes a module or separate glass sheet 10. The Etalon filter 12 is first formed on a polyethylene terephthalate (PET) substrate 14 that is then affixed to the glass sheet by a layer of adhesive 16. Because a plasma display generates infrared radiation and electromagnetic interference (EMI) that must be controlled in accordance with legislated regulations, the filter layers 12 are designed to reduce infrared and EMI from the display. Etalon filters based on multiple silver layers are used to screen infrared wavelengths and electromagnetic waves. Interference between adjacent silver layers can be tuned to cause resonant transmission in the visible region, while providing desirable screening. U.S. Pat. No. 5,071,206 to Hood et al. describes a suitable sequence of layers.

FIG. 1 also includes an antireflection (AR) layer stack 18 that was originally formed on a second PET substrate 20. Antireflection layer stacks are well known in the art. A second adhesive layer 22 secures the PET substrate 20 to the other elements of FIG. 1.

While the PDP filter 12 reduces infrared transmission and EMI from the display, the filter must also be cosmetically acceptable and must enable good fidelity in the viewing of displayed images. Thus, the transmissivity of the filter should be high in the visual region of the light spectrum and should be relatively colorless, so as not to change the color rendering of the plasma display. Further, a general expectation exists that displays should be low in reflectance and that the reflected color be bluish to slightly reddish.

Color can be expressed in a variety of fashions. In the above-cited Hood et al. patent, color is expressed in the CIE La*b*1976 color coordinate system and in particular the ASTM 308-85 method. Using this method, a property is shown by values for a* and b* near 0. Generally, consumers expect that computer displays will appear either neutral or slightly bluish in color. Referring briefly to the La*b* coordinate system shown in FIG. 2, this generally yields the expectation that reflected a* (i.e., Ra*) lies in the range of −2 to approximately 10, and reflected b* (i.e., Rb*) lies in the range −40 to approximately 2. This expectation is shown by dashed lines 23.

Users of large information displays generally expect minimal change in reflected color with changes in the viewing angle. Any color change is distracting when a display is viewed from a close distance, where the color of the display appears to change across the surface. Since plasma display panels are intrinsically large, due to the large number of pixels required for imaging and the large pixel size, the need for reduced color travel with viewing angle is heightened. In particular, it is objectionable if the “red-green” component of color, Ra*, changes substantially with angle. Changes along the other axis, Rb*, are generally less of an issue when the display has large reflected negative Rb* (i.e., strong blue reflected color) at normal incidence.

As previously noted, different factors regarding the design of PDP filters may conflict. Generally, controlling reflected color competes with EM screening capability. Typical silver etalon filters work to screen infrared rays primarily by reflecting the rays. Infrared radiation is relatively close in wavelength to red and is therefore difficult to effectively control while simultaneously obtaining low reflection in the red region of the spectrum (i.e., 620-700 nm). The problem is particularly acute for plasma displays, where it is desirable to shield from Xe emissions at 820 nm and 880 nm while maintaining high transmissivity in the red region of the spectrum.

Controlling reflection within the red region of the light spectrum is rendered even more difficult by the need for a low sheet resistance in the PDP filter 12. Attempts have been made to balance the goals of maximizing red transmission and minimizing sheet resistance. U.S. Pat. No. 6,102,530 to Okamura et al. describes an optical filter for plasma displays, where the filter has a sheet resistance of less than 3 ohms/square. Generally, a sheet resistance of less than 1.5 ohms/square is required to meet Federal Communication Commission (FCC) Class B standard, even for PDP sets having the highest luminance efficiencies. Copper wire mesh PDP EMI filters having a sheet resistance of 0.1 to 0.2 ohms/square are often used to provide Class B compatibility.

The requirement for lower sheet resistance increases the color problem for etalon EMI filters. The transmission bandwidth of the filter becomes narrower as the conductive layers become thicker, resulting in both an increase in the red reflection and a loss of color bandwidth in transmission.

There is a conflict between the tendency of etalon filters to show red reflection at different viewing angles and the generally expected appearance of consumer products. This is known from the design of automotive windshields, where a disagreeable “purple” appearance is produced by reflections of clouds from certain windshields. This objectionable reflection limits the thickness of the conductive layers used in such filters.

FIG. 2 illustrates the difficulty with a four silver layer coating designed for a PDP. The plot 24 shows color as a function of viewing angle from normal incidence to 60 degrees. The four silver layer coating may have an acceptable sheet resistance and may have a total silver thickness of 45 nm to provide an acceptable color appearance at normal incidence. However, as the illustration shows, when the coating is viewed at 60 degrees, the reflected light is strongly red, with Ra* of approximately 30. In addition, there is a large color shift with incidence angle, which creates an apparent color difference across the screen for a large screen viewed at a close distance. Thus, despite the suitability of the coating for some Class B EMI applications, this coating may be considered cosmetically unacceptable.

What is needed is a plasma display filter that addresses the issues regarding emission control, color travel, and color bandwidth in transmission.

### SUMMARY OF THE INVENTION

The plasma display filter of the invention includes at least five metallic layers, such as silver alloy layers, with a combined thickness exceeding 50 nm in order to achieve low reflected red color shift with viewing angle, relatively neutral transmitted color, desirable electromagnetic shielding characteristics, and low infrared transparency. The metallic layers form an alternating pattern with dielectric layers, where the layer of the alternating pattern closest to the supporting substrate is one of the dielectric layers. In the preferred embodiment there are five metallic layers and six dielectric layers.

The supporting substrate may be the plasma display panel, but it is typically a transparent flexible polymeric substrate that is subsequently attached to the plasma display panel. A suitable substrate material is PET. The individual thicknesses of the metallic layers and the dielectric layers within the alternating pattern are tailored to define filter properties that include (a) a reflected color Ra* of less than 20 throughout a range of 0 degrees to 60 degrees angle of incidence, (b) a sheet resistance in the range of 0.5 ohms/square to 1.5 ohms/square, and preferably (c) a color travel along the Ra* axis of less than 10 CIE units throughout the range of 0 degrees to 60 degrees. Each metallic layer may have a thickness in the range of 6 nm to 18 nm, while each dielectric layer has a thickness greater than 10 nm.

In addition to the alternating pattern of metallic and dielectric layers, the plasma display filter may include a color correcting layer that exhibits a negative Ra* shift with increasing angle of incidence. Such a color correcting layer would offset any positive Ra* shift which might otherwise remain. Antireflection and/or hardcoat layers may also be utilized.

In the fabrication of the plasma display filter, the layer stacks are formed on the substrate so as to maintain a sheet resistance of preferably less than 1.0 ohms/square and a reflected color Ra* of less than 20 throughout the range of 0 degrees to 60 degrees angle of incidence to the plasma display. Forming the layer stack includes providing layers which are ordered with respect to distance from the substrate so as to at least partially define the stack as an alternating of layers of a high refractive index material and a silver alloy. A “layer,” as the term is applied to the “alternating pattern,” is defined herein as one or more films that exhibit desired properties, such as a particular weighted refractive index. As one example, one or more of the dielectric layers may be a combination of InOₓ and TiO films, where the different materials are selected and applied to provide protection for the metallic layers (e.g., silver alloy) and to ensure the proper optical properties. A “dielectric layer” is defined herein as a high refractive index layer, i.e., a layer having an index of refraction greater than 1.0. Preferably, the high refractive index layers exhibit a weighted (by thickness) average index of refraction between 1.8 and 2.5. Each silver alloy “layer” may be formed by first sputtering silver and then depositing a cap material (such as titanium) atop the silver, with the cap layer then be subjected to alloying and oxidation. The total thickness of the five or more silver alloy layers exceeds 50 nm.

An advantage of the invention is that the plasma display filter exhibits desirable characteristics with regard to a number of different concerns, including infrared and EMI shielding, color transmissivity, and reflected color shift with angle. Thus, for example, the infrared light transmittance at 950 nm may be less than one percent.

### BRIEF DESCRIPTION OF THE DRAWINGS

FIG. 1 is a top view of a filter on a plasma display panel suitable for the present invention.

FIG. 2 is a plot of color as a function of viewing angle for a layer stack having four silver layers in accordance with the prior art.

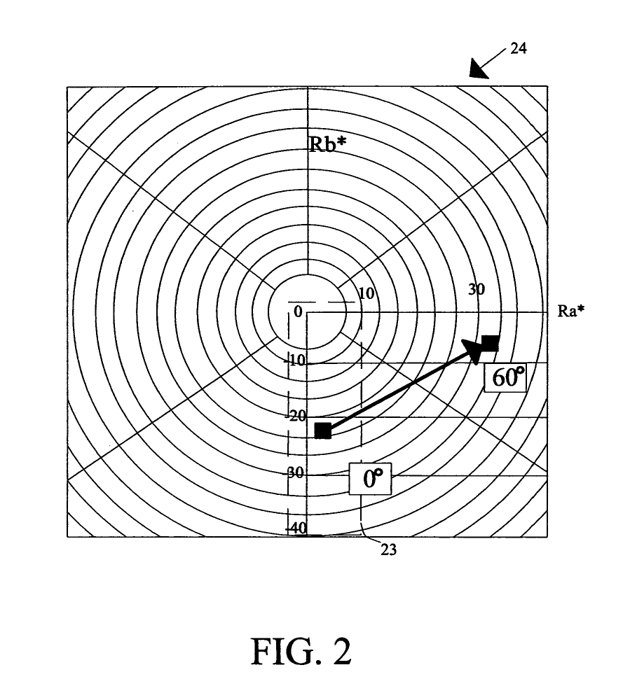

FIG. 3 is a top view of a plasma display filter having a sequence of dielectric and metallic layers in accordance with an embodiment of the present invention.

FIG. 4 is a graph of color properties as a function of the thicknesses of the first and last metallic layers of FIG. 3.

### DETAILED DESCRIPTION

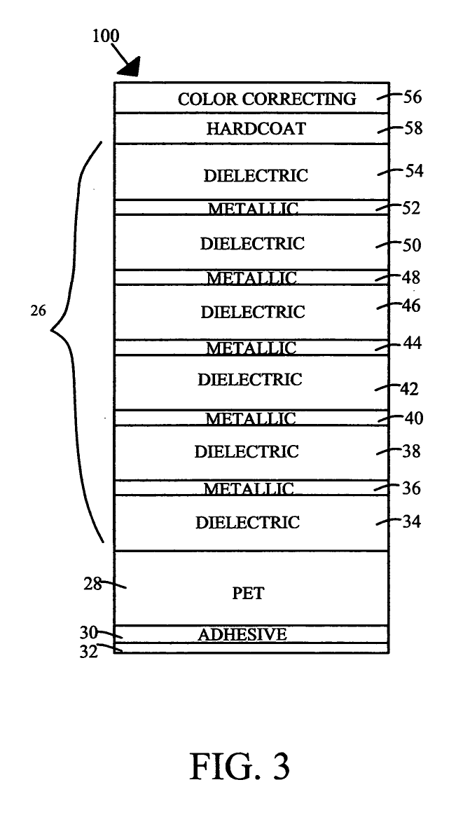

With reference to FIG. 3, an alternating pattern 26 of layers is formed on a flexible polymeric substrate 28. The substrate material may be PET having a thickness of 25 to 100 microns. On a side of the substrate opposite to the alternating pattern is a layer of adhesive 30 and a release strip 32. The release strip 32 is easily removed from the adhesive, allowing the adhesive layer to be used to couple the substrate and its layers to a member for which filtering is desired, such as a PDP. In another embodiment, the alternating pattern 26 is formed directly on a plasma display panel, but there are fabrication complication factors which must be addressed in this alternative embodiment. For example, it might be necessary to pass the panel through a sputter chamber for depositing the material which forms the layers.

In forming the alternating pattern 26 of layers, it is desirable to deposit the materials on the polymeric substrate 28 at near room temperature. The alternating pattern includes at least eleven layers, with the layer nearest the substrate being a dielectric layer 34. While not shown in FIG. 3, there may be a primer layer, an adhesion layer or other layers which promote the structural integrity of the filter 100 of FIG. 3. The alternating pattern 26 is formed to maximize the total quantity of silver, while maintaining a bluish reflected color, high transmission, and neutrality of transmission. In accordance with the invention, these properties are obtained with the use of five metallic layers 36, 40, 44, 48 and 52 having a combined thickness greater than 50 nm. In the preferred embodiment, the metallic layers are silver or silver alloy layers. The silver alloy layers may be formed by first sputtering silver and then sputtering a titanium cap layer which is subsequently subjected to alloying and oxidation. Moreover, it is shown that by annealing the metallic layers, sheet resistance can be reduced to 0.8 ohms/square.

In the fabrication of the filter 100 of FIG. 3, the first dielectric layer 34 may be formed by sputtering dielectric material onto the substrate 28. As previously defined, “dielectric” refers to a high refractive index layer (i.e., a refractive index greater than 1.0). In the preferred embodiment, the refractive index of each dielectric layer 34, 38, 42, 46, 50 and 54 is in the range of 1.8 to 2.5. The thickness of the first dielectric layer is at least 10 nm, with a preferred range of 10 nm to 60 nm. A suitable material is an indium oxide, which may include indium tin oxide. Alternatively, at least one dielectric “layer” of the alternating pattern may be a combination of dielectrics, such as InOₓ and TiOₓ.

Formed atop the first dielectric layer 34 is the first metallic layer 36. A “metallic” layer is a layer having a sufficiently low resistivity to promote an end product having the desired sheet resistance. Each metallic layer may be silver or a silver alloy metal layer. The thickness of the first metallic layer is preferably in the range of 6 nm to 12 nm. A second dielectric/metallic pair in the alternating pattern 26 duplicates the materials of the first pair. The second dielectric layer 38 has a thickness in the range of 70 nm to 95 nm, while the second metallic layer 40 has a thickness in the range of 9 nm to 18 nm. The third and fourth metallic layers 44 and 48 have the same thickness as the second metallic layer 40, within ±20 percent, at least in the preferred embodiment. The thickness of the third, fourth and fifth dielectric layers 42, 46 and 50 is preferably the same as the range of the second dielectric layer 38.

The final metallic layer 52 may be thinner than the middle metallic layers 40, 44 and 48. The thickness of the fifth metallic layer 52 is preferably in the range of 6 nm to 12 nm. Similarly, the final dielectric layer 54 has a reduced thickness, similar to the first dielectric layer 34. The first and sixth dielectric layers 34 and 54 may have a thickness in the range of 20 nm to 60 nm. The various layer thicknesses of the filter 100 can be adjusted within suitable ranges in order to achieve target optical properties for a particular application. If the dielectric layers are equal in thickness and the metallic layers are equal in thickness, a high transparency will result, but with a possible excessive color shift. Therefore, a color correcting layer 56 may be included to provide a color shift that is in the opposite direction, so as to offset the color shift exhibited by the alternating pattern 26. It has been determined that if fewer than five silver alloy layers are used, it is difficult to provide a sheet resistance below 1.2 ohms/square with low color shift with viewing angle.

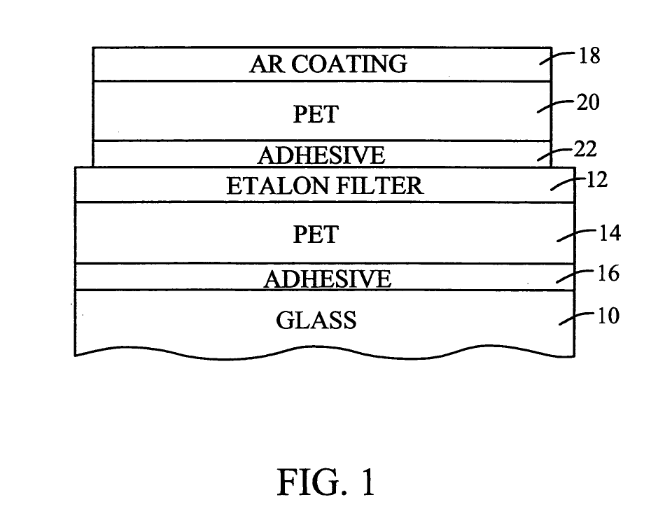

Between the color correcting layer 56 and the alternating pattern 26 is a hardcoat layer 58 that can be included in order to protect the underlying layers from scratches and contamination. Like the color correcting layer 56, the hardcoat layer is included in the preferred embodiment. However, the hardcoat layer is less important if the filter 100 is to be used with a top antireflection coating 18 on a second polymeric substrate 20, as shown in FIG. 1.

The total thickness of the metallic layers 36, 40, 44, 48 and 52 plays a significant role in achieving the desired optical properties. As previously noted, the total thickness should be greater than 50 nm. Optical properties for a filter having six indium oxide layers and five silver layers, where the total thickness for the silver layers was less than 50 nm, were computed. Specifically, the eleven layer thicknesses were 40 nm/10 nm/70 nm/10 nm/70 nm/10 nm/60 nm/6 nm/40 nm/6 nm/20 nm. This is consistent with Example 5 in U.S. Pat. No. 6,104,530 to Okamura et al. Transmission in the visible range of the spectrum (Tᵥᵢₛ), reflection in the visible range (Rᵥᵢₛ) and other optical properties were determined using an optical model calculation for this structure on PET, laminated with clear adhesive to glass and laminated with a commercial antireflective coating. The computed optical properties are shown in Table A. Generally, it is highly preferred that a plasma display have visible reflectance (Rᵥᵢₛ) of less than approximately five percent and that the reflected color at normal incidence (0 degrees) should be such that −Rb* is about 2 or more times larger than Ra*. Additionally, the color travel along the Ra* axis should be less than approximately 10 CIE units between viewing angles of 0 degrees and 60 degrees. From Table A, it can be seen that the filter has a large positive Rb* at 60 degrees, which would result in a brown or yellowish reflection appearance. In comparison, the filter 100 described with reference to FIG. 3 provides a negative or neutral Rb* at 60 degrees, corresponding to a neutral or bluish reflected color. Generally, the filter formed in accordance with the present invention has Rb* in the range of −10 to −20 at normal incidence, and Rb* of less than 2 at 60 degrees. Equally importantly, the sheet resistance may be less than 1.0 ohms/square.

TABLE A

| | Tᵥᵢₛ | Ta* | Tb* | Rᵥᵢₛ | Ra* | Rb* |
|---|---|---|---|---|---|---|
| 0° | 63% | −7.0 | 2.5 | 6.0% | 10.5 | 4.8 |
| 60° | 57.6% | −11.4 | −4.4 | 12.9% | 1.1 | 11.4 |

### EXAMPLE 1

The structure of FIG. 3 may be fabricated using indium oxide as the dielectric material and silver as the metallic material. A thin titanium layer (less than 2 nm thickness) may be deposited on top of each silver layer prior to deposition of the dielectric material, so as to improve the silver conductivity. Table B shows the materials and thicknesses for nineteen layers of one sample formed in accordance with the invention. The alternating pattern 26 of FIG. 3 is comprised of Layers 4 through 14. This alternating pattern is formed on a first PET substrate (Layer 3) that is joined to a thicker substrate (Layer 1) by a layer of pressure sensitive adhesive. Additionally, a color-correcting AR coating (i.e., an AR coating exhibiting a negative Ra* shift with increasing angle of incidence) is achieved by the combination of Layers 17, 18 and 19. The color correction is a result of a proper selection of materials having particular indices of refraction. In the embodiment of Table B, the indices of refraction for Layers 17 through 19 are 1.9, 2.3 and 1.5, respectively. The color-correcting AR coating is formed on another PET substrate (Layer 16), which is coupled to Layer 14 by a PSA layer (Layer 15).

TABLE B

| Layer # | Material | Thickness |
|---|---|---|
| 1 | SiO₂ | 3.2e⁶ |
| 2 | PSA | 2.5e⁴ |
| 3 | PET | 5e⁴ |
| 4 | InOₓ | 40 nm |
| 5 | Ag | 9 nm |
| 6 | InOₓ | 89 nm |
| 7 | Ag | 13 nm |
| 8 | InOₓ | 85 nm |
| 9 | Ag | 13 nm |
| 10 | InOₓ | 87 nm |
| 11 | Ag | 13 nm |
| 12 | InOₓ | 90 nm |
| 13 | Ag | 8 nm |
| 14 | InOₓ | 43 nm |
| 15 | PSA | 2.5e⁴ |
| 16 | PET | 5e⁴ |
| 17 | InOₓ | 55 nm |
| 18 | NbOₓ | 95 nm |
| 19 | SiO₂ | 87 nm |

Table C shows the optical properties of a laminated plasma display filter having a two-layer antireflective coating under a C2° illuminant. The optical properties were measured at normal incidence, unless otherwise specified in the table. The sheet resistance was measured as 0.95 ohms/square using an inductive probe.

TABLE C

| | | | | | Ra* | Rb* | Ra* | Rb* |
|---|---|---|---|---|---|---|---|---|
| Tᵥᵢₛ | T₈₅₀ | Ta* | Tb* | Rᵥᵢₛ | (0°) | (0°) | (60°) | (60°) |
| 57.5% | 0.3% | 1 | −5 | 4.5% | 1.7 | −21.7 | 6.1 | −11.5 |

### EXAMPLE 2

A sample of the structure formed in accordance with FIG. 3 was laminated as in FIG. 1, with a commercial antireflective coating 18. The structure was then annealed for 48 hours at 100° Celsius in air. The annealing did not change the optical properties in transmission or in reflection. However, the sheet resistance was reduced from 0.96 ohms/square to 0.80 ohms/square.

### EXAMPLE 3

In another sample, the coating as described in Example 1 was over-coated with an acrylic antiglare hardcoat, such as the hardcoat 58 in FIG. 3. The structure was then laminated to a glass sheet. The resulting sample exhibited excellent transmission and reflection characteristics. The sheet resistance was 1.0 ohms/square.

### EXAMPLE 4

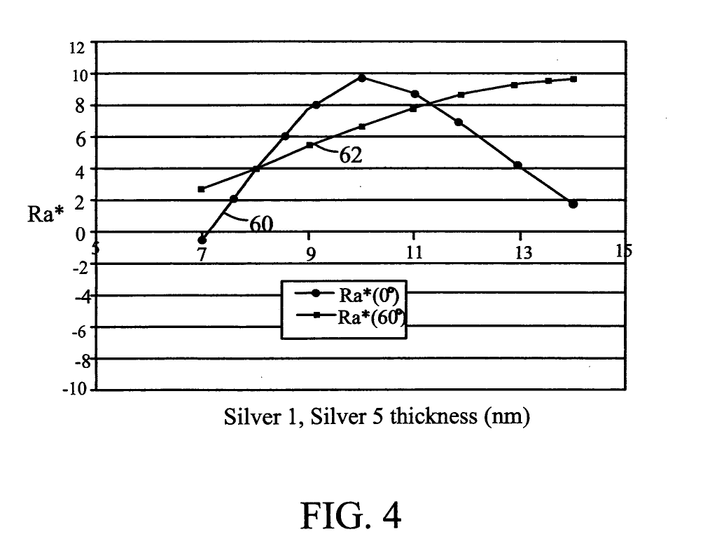

FIG. 4 shows plots of Ra* for thicknesses of the first and fifth silver layers of a five-silver layer stack. Here, the thicknesses of the two silver layers are equal. The thicknesses of the other three silver layers may also be equal (e.g., 13 nm). In FIG. 4, there is a plot 60 of Ra* as measured at 0 degrees and a second plot 62 of Ra* as measured at 60 degrees.

As shown in FIG. 4, when the thicknesses of the first and fifth silver layers are between 8 nm and 12 nm, there are desirable properties with respect to color shift with angle and sensitivity to color shift with metal thickness. This thickness range is also more tolerant to manufacturing variations. Generally, for various layer thicknesses, it has been found that the layer sensitivity is minimized and the color shift with angle is minimized when the outer two metal layers have a thickness that is between 55% and 85% of the average metal layer thickness of the middle three silver layers. More preferably, the range is between 60% and 80%. However, it is not necessary for the two outer silver layers to have the same thickness, if they lie within the specified range.

Thus, the advantages of the described plasma display filter are less apparent when the total thickness of the silver layers is below 50 nm. Moreover, for very thin silver layers, with a high optical bandwidth, it is difficult to achieve low transmission at 850 nm. The invention described above, which allows thicker silver layers to be used, is particularly useful in obtaining excellent infrared blocking properties.

What is claimed is:

1. A plasma display filter comprising:
a substrate; and
a sequence of layers on said substrate, said sequence including at least six dielectric layers and at least five metallic layers, said dielectric and metallic layers being disposed in an alternating pattern in which one of said dielectric layers is the layer of said alternating pattern closest to said substrate;
wherein a combined thickness of said metallic layers in said alternating pattern is greater than 50 nm and wherein individual thicknesses of said metallic layers and said dielectric layers define filter properties that include:
(a) a reflected color Ra* of less than 20 throughout a range of 0 degrees to 60 degrees angle of incidence; and
(b) a sheet resistance in a range of 0.5 ohms/square and 1.5 ohms/square.

2. The plasma display filter of claim 1 further comprising a color correcting layer that exhibits a negative Ra* shift with increasing angle of incidence.

3. The plasma display filter of claim 1 wherein said metallic and dielectric layers further define a filter property (c) in which color travel Ra* is less than 10 CIE color units throughout said range of 0 to 60 degrees angle of incidence.

4. The plasma display filter of claim 1 wherein each metallic layer is a silver alloy layer having a thickness in the range of 6 nm to 18 nm.

5. The plasma display filter of claim 4 wherein at least one said silver alloy layer includes titanium.

6. The plasma display filter of claim 1 wherein said substrate is a flexible polymeric substrate.

7. The plasma display filter of claim 6 wherein said flexible polymeric substrate is PET.

8. The plasma display filter of claim 1 wherein said metallic layers are sputtered silver layers.

9. The plasma display filter of claim 1 wherein said filter property (b) is one in which said sheet resistance is less than 1.0 ohms/square.

10. A method of providing a filter for a plasma display comprising:
providing a transparent substrate having a flexibility which enables efficient lamination; and
forming a layer stack on said substrate so as to maintain a sheet resistance of less than 1.0 ohms/square and a reflected color Ra* of less than 20 throughout the range of 0 degrees to 60 degrees angle of incidence to said plasma display following said lamination of said substrate, said forming including providing layers which are ordered with respect to distance from said substrate so as to at least partially define said layer stack as including:
a first high refractive index layer having a thickness greater than 10 nm;
a first silver alloy layer having a thickness between 6 nm and 12 nm;
a second high refractive index layer having a thickness greater than 70 nm;
a second silver alloy layer having a thickness between 9 nm and 18 nm;
a third high refractive index layer having a thickness greater than 70 nm;
a third silver alloy layer having a thickness between 9 nm and 18 nm;
a fourth high refractive index layer having a thickness greater than 70 nm;
a fourth silver alloy layer having a thickness between 9 nm and 18 nm;
a fifth high refractive index layer having a thickness greater than 70 nm;
a fifth silver alloy layer having a thickness between 6 nm and 12 nm; and
a sixth high refractive index layer having a thickness greater than 10 nm.

11. The method of claim 10 wherein each of said first through sixth high refractive index layers exhibits a weighted average index of refraction between 1.8 and 2.5.

12. The method of claim 10 wherein each of said layers is sputter deposited.

13. The method of claim 10 further comprising forming a top protective layer on a side of said layer stack opposite to said substrate.

14. The method of claim 10 wherein forming each of said first through fifth silver alloy layers includes sputtering silver and depositing a titanium cap atop said silver.

15. The method of claim 14 wherein forming each of said first through fifth silver alloy layers includes subjecting said titanium cap to alloying and oxidation.

16. The method of claim 10 wherein providing said transparent substrate comprises providing a web of PET.

17. The method of claim 10 wherein forming said layer stack includes providing a color correcting layer that exhibits a negative-going Ra* shift with an increasing angle of incidence.

18. The method of claim 10 wherein forming said layer stack includes providing a combined thickness of said first through fifth silver alloy layers that exceeds 50 nm.
